(19) United States
(12) Patent Application Publication
(10) Pub. No.: US 2012/0271701 A1
(43) Pub. Date: Oct. 25, 2012

(54) INTERNET-BASED SYSTEM AND METHOD TO COMPENSATE FULL VALUE OF NON-COMMERCIAL USER ACTIONS

(76) Inventor: William Fitzgerald Keck, Huntington Beach, CA (US)

(21) Appl. No.: 13/540,540

(22) Filed: Jul. 2, 2012

(51) Int. Cl. G06Q 30/02

(52) U.S. Cl. 705/14.25

(57) ABSTRACT

An internet-based method for compensating non-commercial user actions, the method comprising the steps of: receiving from a seller a description of its product offering, and parameters of its offering including the percentage of seller's profit to be realized from the sale of the product during a preset sale period, which seller agrees to share with users who indicate interest in the seller's product; displaying at least a portion of the description of the seller's product offering on a document of a web platform; facilitating at least one indication of interest in the seller's product by users, including recording at least one of user's indication of interest; providing data to seller regarding the interest indicated by users in the seller's offering; receiving payment from seller, the payment including said percentage of seller's profit; and, distributing to users their share of the payment received from seller.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates generally to internet-based systems and methods, and more particularly to an internet-based system and method for allowing users to realize the full value of their expressed interest, in sellers' offerings of goods or services, through non-commercial user actions.

2. Description of the Related Art

Today, companies that offer goods and services for sale via the Internet issue a direct monetary reward or monetary value typically in the form of a lower price on a good or service for a user when the user refers other users who purchase or otherwise perform some function for the company issuing the reward. This process is typically tracked by refer codes that map the exact action of the second user, typically but not always a purchase, back to the first user, who then is given the reward by the issuing company. When there is a direct financial gain to the referring user, these rewards are dependent on a subsequent action by a second user or a fiduciary action by the original user.

Two limitations of this existing reward system are (1), that it does not allow the referring user to gain maximum benefit from her actions that benefit a company, such as recommending the goods and services of the company through word of mouth referrals for example, and from secondary referrals that are not tracked, but would not have occurred if the first referral had not taken place. And (2), the existing reward system relies on subsequent action, in most cases commercialized behavior, a commercial action by the second or subsequent user, in order for the first action to be measured and compensated.

Thus, there is a need in the art for a new system and method that rewards users with a monetary value for actions that are not fiduciary in nature, that are not tied to purchasing a product, and that are not dependent on any subsequent action, either by the original user or by a second user, whether the subsequent action is fiduciary in nature or otherwise. Such system and method need to also account for the full value of the original action of a user, even if it is merely the expression of interest in a seller's offering, including instances where the user's actions cannot otherwise be tracked, but nevertheless influences the entire market and success of the seller's offering.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, an Internet-based system and method is provided to reward users who express and share interest on goods and services offered by sellers by performing non-commercial actions and without users having the obligation to purchase the goods and services, and without the requirement of any subsequent action by the user or any second or subsequent user. Thus, an advantage is that the system tracks not only the value of user interest with specific measurement, but also accounts for secondary and aggregate effects of the original user interest when it is shared, even in cases where there is no tracking available to make the connection between cause and effect. Another advantage is that the system accounts for how a user influences the entire market in all instances when she expresses or shares her interest in a seller's offering.

In another exemplary embodiment, a method and system is provided for sellers to create an offering of goods or services in which users of the Internet-based system can express interest in by a single action via click or touch in any Internet-enabled or mobile device. The method further includes allowing sellers to indicate the percentage of profit available in the offering that will be shared with users who indicate their interest in the offering, rewarding users with a percentage of that profit as monetary gain without requiring any commercial or fiduciary action from the users or any secondary users with whom the first users shared interest in the offering. Thus, an advantage is that the method allows mere indication of interest to create a value that is tracked and monetized by the user expressing or sharing interest.

In another exemplary embodiment, a method and system is provided for sellers having an offering of goods and/or services to share and distribute profit as a reward for user's actions, even in cases where the secondary and subsequent effects of user actions are not tracked. Thus, an advantage is that the system accounts for the full value of user interest and the market value it creates, even in cases where the user does nothing more than express interest in the seller's offering without any further commitment or commercial or fiduciary action of any kind

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a schematic drawing of an exemplary Internet-based system which may be used to implement a method for compensating full value of non-commercial user actions, according to one embodiment.

FIG. 2 shows a flow chart of the method for compensating full value of non-commercial user actions from the web platform operator's perspective.

FIG. 3 shows a flow chart of the method for compensating full value of non-commercial user actions from the seller's perspective.

FIG. 4 shows a flow chart of the method for compensating full value of non-commercial user actions from the user's perspective.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

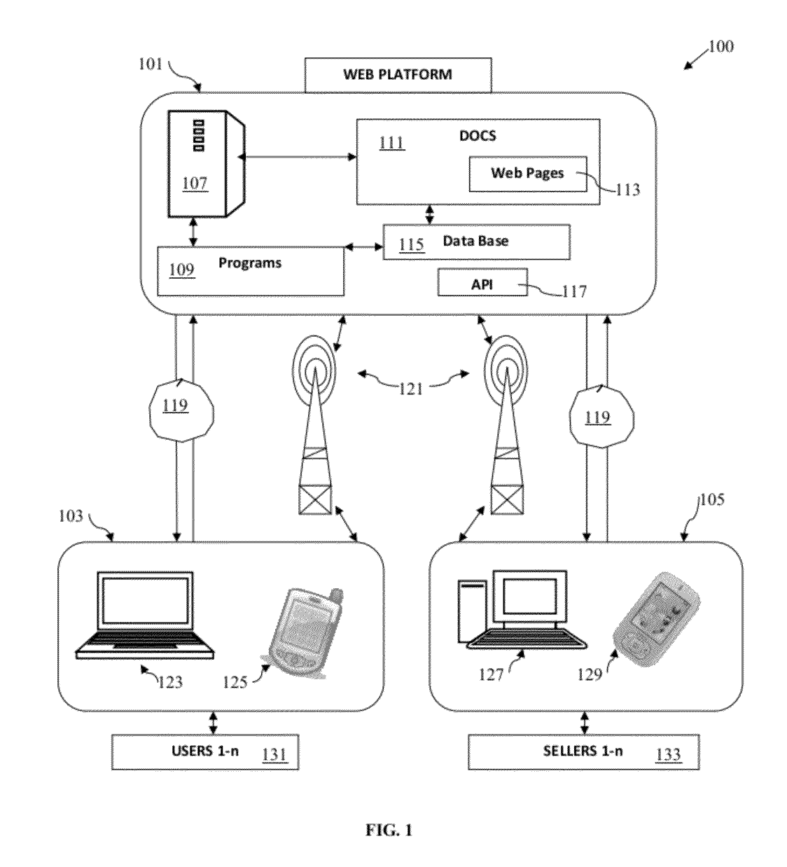

FIG. 1 illustrates a schematic drawing of an exemplary Internet-based system 100 which may be used to implement a method for compensating full value of non-commercial user actions, as described herein. As it will be explained in more details below, the system and method provides users a way to indicate (i.e., express and/or share) interest in a seller's offerings in exchange for rewarding them with a share of a percentage of the profit of the seller's offering of goods or services, without the obligation to purchase any good or service, and without any other commercial or fiduciary responsibility by the user taking the original action or by any subsequent user.

As shown in FIG. 1, the system 100 may include an Internet-based compensation system (“web platform,” “internet platform,” “internet-based system,” “internet system,” “mobile platform”, or “platform”) 101, which may be accessed by users 131 via user devices 103, such as a personal computer (“PC”) 123 or a mobile device 125 (e.g., a smart phone or a tablet computer). User devices 103 may connect to the web platform 101 via an internet link/connection 119, which may be wired or wireless, a mobile/cellular network 121, a satellite communication network (not shown), or the like, or a combination thereof.

Similarly, sellers 133 who wish to promote their goods and/or services using the web platform 101 may access the web platform 101 using seller devices 105, such as a seller computer 127 (e.g., a PC) or a seller mobile device 129, such as a smart phone or a tablet computer. Seller devices 105 may also connect to the web platform 101 via an internet link 119, a mobile network 121, a satellite communication network (not shown), or the like, or a combination thereof

As it would be recognized by one of ordinary skills in the art, the web platform 101 may be configured such that the users 131 and sellers 133, through their devices 103 and 105, respectively, may communicate and/or interact with the web platform 101 via standard applications such as web browsing using a web browser, text messaging (e.g., SMS), or the like. Alternatively, and/or concomitantly, specially programmed applications (“apps”), such as web apps, native apps, mobile apps, hybrid apps, or a combination thereof, configured to work with (i.e., access, view, interact with, etc) the web platform 101, may be provided (e.g., for download) to both, the users 131 and the sellers 133. Furthermore, the web platform 101 may be configured such that it may be accessed and/or interacted with through a combination of, for example, a web browser and an app. In addition, the web platform's documents and data may be made available through a mobile website as well. Thus, it should be understood that various programs, applications, technologies, and/or approaches, now known or later developed, may be adopted to facilitate accessibility, viewing and/or interaction with the web platform's documents, data, and other components, as described herein, without departing from the scope of the invention.

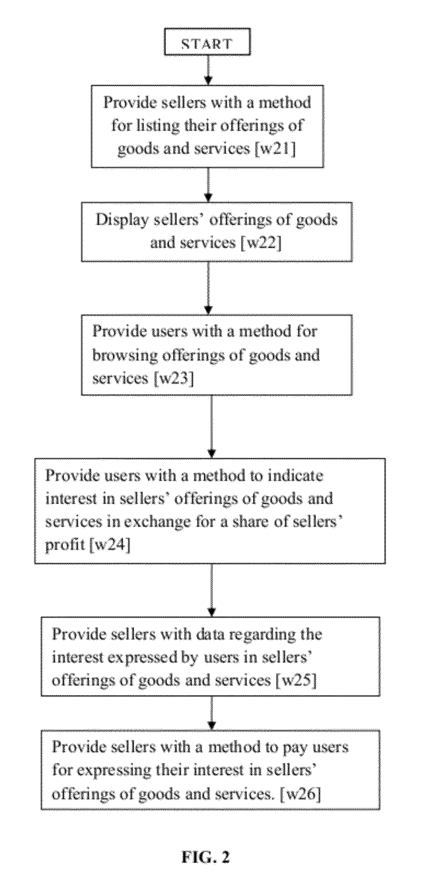

The web platform 101 may include a server 107, or a group of networked servers, which may store and/or run program(s) 109, application program interface (API) 117, database(s) 115, documents 111 (such as web pages 113). It should be understood that the web platform's documents and data may be in the format(s) required to facilitate access, viewing and/or interaction by the users 131 and/or sellers 133, depending on the technology/approach chosen as explained above. For example, the documents may be html documents if browsing using standard web browser or mobile web browser is contemplated. The program(s) 109 and the other elements (database 115, documents 111, etc) of the web platform 101 will be configured by a computer/web programmer to enable the web platform 101 to implement the method for compensating full value of non-commercial user actions, as described herein (see description below referring to FIGS. 2-4).

The web platform 101 is preferably owned and/or administered/operated by an independent third party. However, a seller, an association of sellers, or an agent of the seller(s) may own and/or operate the web platform 101 as well. Users may own/operate the platform as well.

FIG. 2 shows a flow chart of the method for compensating full value of non-commercial user actions from the web platform operator's perspective. The web platform 101 (FIG. 1) is preferably configured to provide sellers 133 with a way to list (i.e., Step w21, FIG. 2) their offerings (e.g., their goods and services they are willing to promote, geographic area(s) selected, profit share offered, duration of the promotion, etc) into the web platform 101. This may be accomplished by, for example, using web forms or online questionnaires, the input to which may then be submitted/uploaded into the database 115. While completing the questionnaire, the seller 133 may be allowed to submit text, images, videos, documents (e.g., pdfs), a combination thereof, or other data. The data submission by seller 133 may occur entirely or partially offline as well and then the data may be inputted into the web platform 101 by the operator; however, preferably, a seller 133 submits the data directly to the web platform.

The questionnaires may be designed to solicit mandatory data/information from the sellers 133 (e.g., name, address, goods and services, profit share offered etc) and/or to suggest additional information (e.g., geographical areas, user categories (e.g., age groups), etc). Furthermore, before a seller 133 submits its questionnaire answers to the web platform 101, the seller may be required to agree to certain terms and conditions including but not limited to, for example, a requirement to agree to share a set percentage (e.g., 20%) of seller's profit obtained during a set period of time (i.e., “sale period”; e.g., next six months) and/or to agree with the respective percentage being split between the users 131 and the web platform operator (e.g., 15% to users and 5% to operator).

Next, in step w22, the web platform 101 uses the data submitted by seller 133 to create documents (e.g., web pages 113) and displays the documents such that they are available to the users 131 for viewing, by, for example, browsing (step w23) the web pages 113 using a web browser running on the user devices 103. The profit percentage the seller(s) 133 agreed to offer may or may not be made available for viewing to the users 131. The choice may be made by the web platform operator independently or in collaboration with the seller. For example, the profit percentage may be hidden from the users 131 in order to, for example, enhance the variable/unknown aspect of the potential user earnings. Alternatively, the percentage of profit sellers 133 offer may be shown to users 131 in order to, for example, provide additional information to users 131 which they may then use to decide which seller's goods or services to express interest in. Even in the later case, the variability and the unknown aspects of the potential user earnings are still maintained because of the unknown level of future profit to be obtained by seller.

In step w24, the users 131 are preferably provided with a method to indicate (express and/or share) interest in sellers' offerings of goods and services in exchange for a share of sellers' profit. After browsing, for example, through various offerings of several sellers 133, the user 131 may select one or more goods or services to express interest in, by non-commercial action(s) such as a mouse click or a touch on a user device 103. Such user actions are then preferably recorded and maintained by web platform 101 in a log. The web platform 101 may then use this data to, for example, create and display statistics in the form of, for example, the number of interests expressed for a particular good or service for other users to see, thus, attracting other users to express and/or share interest as well, in order to stimulate a viral marketing effect, thus, increase sale, and thus, the value of the preset seller's profit share that will be distributed to all users. Such statistics may be shown as numbers (e.g., number of followers), trend graphs, and so on.

It is important to note that the users' actions are non-commercial. The users 131, whether original or subsequent (e.g., users referred by original users), have no obligation to purchase sellers' goods or services or to perform any other additional or subsequent commercial or non-commercial action. Simply expressing interest in a good or service may entitle a user to a share of the seller's profit.

Next, in step w25, the web platform 101 may be configured to provide sellers with data regarding the interest expressed by users in sellers' offerings of goods and services. The purpose of making the interest data available to the sellers is to, for example, confirm to sellers that the minimum number of interests that may have been guaranteed by the web platform operator was reached, and thus, the sellers are obligated to pay the set share of the profit.

In step w26, a method may be provided to pay users 131, preferably, directly through the web platform 101, for expressing their interest in sellers' offerings of goods and services. As mentioned before, the payment is preferably a percentage (e.g., 20%) of the seller's profit (e.g., gross profit or net profit, or the like) which may be divided between the web platform operator (e.g., 5%) and the users (e.g., 15%). Typically, the sellers 133 will pay the profit share to the web platform operator, who after retaining its share (e.g., 5%), will pay the users (e.g., 15%) based on, for example, the number of interests expressed (e.g., by clicking a button displayed in the web page of the web platform 101) and/or the number of sharing actions (e.g., sending a message to a friend through the web platform 101, recommending, or simply informing about, a seller's good or service). As one of ordinary skills would recognize, the entire payment process may be completely automated through the web platform 101.

Other payment arrangements may also be made without departing from the scope of the invention. For example, arrangements may also be made such that a seller 133 pays the operator of web platform 101 a fixed fee, through the web platform 101 or through other channels, for using the web platform, and then the seller 133 pays the users 131 directly through the web platform 101.

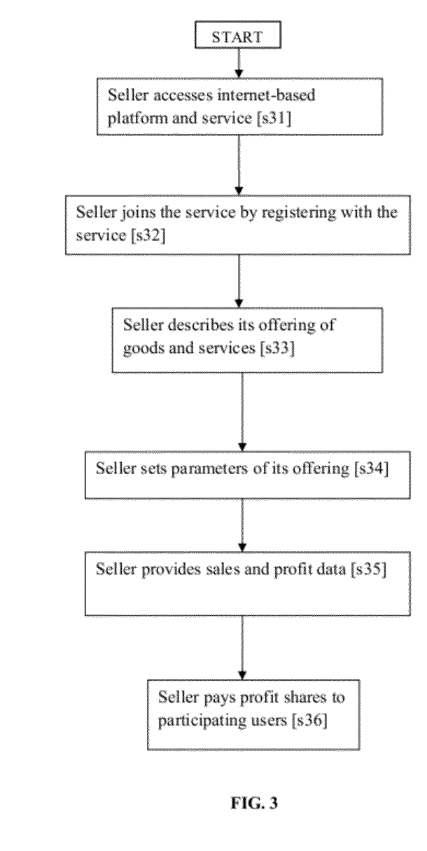

FIG. 3 shows a flow chart of the method for compensating full value of non-commercial user actions from the seller's perspective. As shown, first, in step s31, typically a seller 133 accesses the internet-based platform and service (i.e., the web platform 101 in FIG. 1) by entering the platform's URL via a web browser running on seller's device 105. Next, in step s32, in order to use the service to promote its goods or services, a seller is typically required to join the service by registering with the service. The registration with the service may include creating a profile, creating a login (user id and password), and so on. Once registered, next (step s33), a seller is typically required to describe its offering of goods or services. For example, if the seller is in the business of selling music, the seller may be required to submit to the web platform 101 data such as the title of the song or album, singer's name, price, a picture of the singer and/or the album cover, and so on, and/or a sample of a portion of a song, or of an entire song, in audio and/or video format.

Next, in step s34, the seller preferably sets the parameters of its offering and/or promotional campaign through the web platform. Such parameters may include the geographic areas of seller's offering of goods and services on the internet-based platform 101, defining each area as a separate market, the sale period for which the offering is set, and the percentage of total gross profit (or net profit, or revenue, etc) realized from the sale of its listed goods and services that it makes available to users located in each market to share in, after the users express or share their interest in the offering via non-commercial actions as described herein.

In step s35, the seller may be required to provide sales and profit data to the web platform 101 or its administrator/operator for the purpose of calculating and/or verifying the percentage of profit, and thus, the amount to be shared among the users that expressed interest in the seller's goods and services as described herein. Next, in step s36, the seller pays profit shares to participating users, typically, as described earlier, through the web platform. As mentioned before, the operator of the web platform may retain a portion of the respective percentage of profit for itself, as compensation for its service, before distributing the balance to the users.

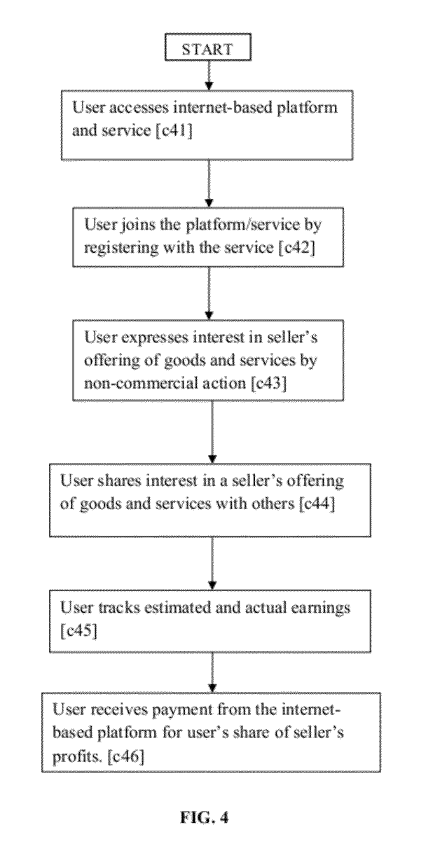

FIG. 4 shows a flow chart of the method for compensating full value of non-commercial user actions from the user's perspective. As shown, first, in step c41, typically, a user 131 accesses the internet-based platform and service (i.e., the web platform 101 in FIG. 1) by entering the platform's URL via a web browser running on user's device 103. Next, in step c42, in order to use the service, a user may be required to join the service by registering with the service. The registration with the service may include creating a profile, creating a login (user id and password), and so on. Next, a user 131 may browse through the web pages 113 of the web platform 101 and she may select one or more seller's offerings to express interest in (step c43), by, for example, clicking or touching a button as described earlier.

User 131 may also chose to share (step c44) her interest in a seller offering (e.g., a song) with others, as such an action would also give her points, and thus, would increase her share of the seller's profit. Thus, the sharing entitles the user to additional share of the percentage of the profit from the offering of goods and services that the user expressed interest in, with no limit set to possible value, since value will be determined by the success of the sellers offering of goods and services in the market. User 131 may share her interest by, for example, telling a friend about the web platform and/or about a particular good or service of a seller through the web platform 101, or, even through outside channels (e.g., social media sites, email, phone, in-person communication, etc) and then reporting the action to the web platform 101, which is preferably monitored by the platform to prevent fraud, and by any other user activity causing a viral marketing effect, or “buzz,” or the like, which may increase seller's sales and profit, and thus, the users gain. It should be noted that even sharing activities external to the web platform 101 and not reported to the web platform, may ultimately benefit the user as those activities may cause an increase in the seller's profit. Thus, there is an incentive for the user to perform all sharing actions available to her using outside channels even if those actions are not reported to the web platform.

In step c45, user 131 tracks estimated and actual earnings through her web platform 101 account she created when she registered with the platform. Next, in step c46, the user 131 receives payment from the internet-based platform 101 for user's share of seller's profits, as described earlier.

It should be understood that agreements, consistent with the above described method, between the web platform 101 owner/administrator/operator and users 131 and between the web platform 101 owner/administrator/operator and sellers 133 will typically have to be agreed to, preferably through the web platform 101 (e.g., Terms of Use Agreements, one for users and one for sellers, displayed and agreement required by click or touch of a button before registration of users 131 or sellers 133 is permitted).

It should be noted that, preferably, a user 131 may only express interest once in the same product (i.e., good or service). For example, if the product is a song, the web platform 101 may be configured to allow a user 131 to express interest by following that song. The following of the song may be accomplished by clicking or touching a button which may be called “Follow,” “Be a Fan” or the like.

Users 131 may be allowed to unfollow, but once they do, preferably, they no longer get a share of profits gained as a result of the sale of that song in the market place by the seller 133, and, preferably, they are not allowed to follow again the same song. The reason for this arrangement is that there is preferably a limit to how many offers (e.g., songs) a user can follow, which may make it more of a game, so that the users 131 have to choose the best offers in their view (e.g., offers with the greatest perceived earning potential) to follow. There may also be limits set on how many people may follow a song, which may incentivize people to follow early.

For each action a user 131 takes (e.g., following a song, sharing a song, etc), she is typically awarded a certain amount of action points to her account established with the web platform 101. For example, a number of points may be awarded for an action based on the preset value of the action, which is a parameter that typically the administrator of the web platform 101 sets (with or without the agreement of the sellers 133); however, the preset value may be set by seller 133 as well.

The available profit for distribution to users 131 is then preferably calculated by the web platform 101 as a percentage (e.g., 20%, 50%, etc) of the total profit generated by the seller 133 from selling the particular product (e.g., a song) through all trade channels the seller chooses to employ. Then, the amount obtained is preferably divided evenly by the total number of action points all users have earned, resulting in a profit share value (e.g., $4) for each action point. Next, each user gets her total profit share (e.g., $500) by multiplying her action points total (e.g., 125 points) with the profit share value per point (e.g., $4). The following example may further help understand this process:

1. A follow (expression of interest) action is set to 20 points;

2. A sharing action is set to 10 points;

3. All participating users' points total 300 for the offering in a given sale period;

3. The seller has $2,400 in profit in the sale period, of which 50% is available to share with the users; thus, $1,200, is divided by 300 points; hence, each action point is worth $4;

4. Thus, each user gets $4 for each action point they have earned.

It should be understood that the above example is oversimplified and super condensed, and thus, offered for illustration purposes only.

Again, it should be noted that user's non-commercial expression of interest may mean clicking or touching a button displayed in a web page of the web platform 101, and sharing of interest may mean telling (e.g., recommending, informing, etc) a friend about a particular product or service of a seller 133 through the web platform 101 or through outside channels (e.g., social media sites, email, phone, in-person communication, holding a street sign, etc) and then, optionally, reporting the action to the web platform and any other user activity causing viral marketing effect, or “buzz,” or the like, with verification measures such as account verification and monitoring of actions, proof submission requirement (e.g., picture depicting street sign holding), and so on, to insure accuracy and eliminate fraud.

It should also be noted that while the user is not required to purchase a good or a service, a user may choose to do so on her own, for example, for the purpose of boosting her credibility with other potential users to whom she may choose to recommend that good for the purpose of expressing interest through the web platform 101, or sharing the interest, and thus, participate in the profit sharing arrangement.

The method described herein may also account for the relative value of the sharing actions based on the geographic location of the user sharing and expressing the interest with, for example, the use of countries of the user as a basis for division of market segment or other geographical boundaries, so that the value of each action by the user is accurately reflected by its impact in the market of that geographically defined market segment.

It should also be understood that a user may gain not only from her direct actions as described above (e.g., expressing interest in a product by clicking a button displayed in a web page of the web platform 101, etc), but also for the actions of all subsequent users who expressed or shared interest in that product because of user's action(s). Thus, for example, when a user recommends a product or simply sends information about the product (i.e., sharing interest) to a first subsequent user, who then joins, or doesn't join the platform but chooses to share interest in the product with a second and a third subsequent user, the (original) user will likely benefit. This is because all the actions of the subsequent users will likely lead to greater profit realized by the seller of the product, and thus, the amount the original user will receive as her share of the seller's profit will be greater as well.

The subsequent users' actions are normally tracked only if they use the web platform 101. In that case, they are awarded profit based on their action points, in the same way as the original users. However, the method described herein also accounts for untracked actions of all users (e.g., a positive message posted on a social media site) because they impact the total profit offering of a product listed on the web platform 101. Thus, for example, if a subsequent user, who is not a user of the web platform 101, recommends (or purchases) a product, she influences the total profit, but only the users 131 of the web platform 101 will preferably share in that profit. Again, this arrangement provides an extra incentive to users 131 to use not only the tools available through the web platform 101, but also all the tools available to them outside the platform (e.g., making a phone call, posting a message on a social media site, etc).

It should be apparent from the above description that, in one embodiment, disclosed herein is an Internet-based system and method to reward users who express and share interest, in goods and services offered by sellers, by performing non-commercial actions and without users having any obligation to purchase the sellers' goods and services, and without any requirement of any subsequent action by users or any second or subsequent users. Thus, the system tracks not only the value of user interest with specific measurement, but also accounts for secondary and aggregate effects of the original user interest when it is shared, even in cases where there is no tracking available to make the connection between cause and effect. In addition, the system accounts for how a user influences the entire market, in all instances when she expresses or share her interest in a seller's offering.

In another embodiment, a method and system is provided for sellers to create an offering of goods or services in which users of the Internet-based system can express interest in by a single action via click or touch in any Internet-enabled or mobile device. The method further includes allowing sellers to indicate the percentage of total gross profit available in the offering that will be shared with users who indicate their interest in the offering, rewarding users with a percentage of that profit as monetary gain without requiring any commercial or fiduciary action from the users or any secondary users with whom the first users shared interest in the offering. Thus, the method allows mere indication of interest to create a value that is tracked and monetized by the user expressing the interest.

In another embodiment, a method and system is provided for sellers having an offering of goods and/or services to share and distribute profit as a reward for user's actions, even in cases where the secondary and subsequent effects of user actions are not tracked. Thus, the system accounts for the full value of user interest and the market value it creates, even in cases where the user does nothing more than express interest in the seller's offering without any further commitment or commercial or fiduciary action of any kind.

In another embodiment, a method is provided for users to express interest in an offering of goods and services of sellers, recording users' interest electronically via an Internet-based system, tying the user's interest to a point in time that allows the seller to reward the user with a percentage of gross profit of the offering for any period in which the seller has designated participation by users who have expressed interest via the Internet-based system, beginning with the point in time in which the users expressed interest.

In another embodiment, a method is provided for all users to see the interest by other users in an offering of goods and services by a seller, resulting in an attraction of new users to the offering because of the popularity of the interest expressed by other users.

In another embodiment, a method is provided for sellers to set a value for user actions that share their interest in an offering of goods and/or services with other people, that ultimately results in sellers distributing gross profit as a reward for that shared interest, even in cases where the interest is shared in ways that are not typically tracked electronically, relying instead on the user to log and record their actions in the Internet-based system, even in cases where the user's interest in the seller's offering is expressed to people who are not also users of the system, thus capturing the full value of the user's expressed interest in the seller's offering for all possible methods of sharing interest.

In another embodiment, a method is provided for all users to make sharing actions, via the Internet-based system and otherwise, indicating their interest in a seller's offering of goods and/or services that are non-commercial in nature, that do not require a subsequent action and do not require a purchase of any kind by any user, by neither sender nor receiver, nor any subsequent person, in order to be valid, while at the same time tracking these actions for future profit distribution by the seller of the goods and/or services.

In another embodiment, the method also includes the following: providing an Internet-based platform accessible to sellers of goods and services who wish to obtain interest in their offerings from users who will express interest in their offerings and may elect to share that interest with others; sellers indicating a percentage of profit that is available for disbursement to users expressing interest and/or the minimum amount of time since interest was indicated required to participate in their offering; users indicating that they wish to participate in the offering, and tying them to a point in time when the users' interest will affect the market and thus the profitability of the goods or services; allowing sellers to set a value to each action taken by users who express or share interest in the offering with others, even in cases where the method of sharing is not verifiable through current technology; users making sharing actions, via the Internet-based system and otherwise, indicating their interest in a seller's offering of goods and/or services that are non-commercial in nature, that do not require a subsequent action of any kind and do not require a purchase of any kind in order to be valid, and that also allow users to track and log expressions of interest such as word of mouth that are not otherwise verifiable independently; calculating the value of each sharing action, or interest expression action, via the Internet-based system and otherwise, indicating a user's interest in the seller's offering of goods and/or services, that each user has taken, and use it as a basis to divide the profit percentage, that has been made available to users through the Internet-based system; accounting for the relative value of the sharing actions, and/or interest expression actions, based on the geographic location of the user sharing and/or expressing the interest; and, making payments to the users who have expressed and/or shared interest in the seller's goods and/or services through the Internet-based platform.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Furthermore, although the term “web platform” is predominantly used herein, for the purpose of this application, the term is synonymous with the following terms: “Internet-based compensation system,” “internet platform,” “internet-based system,” “internet system,” “mobile platform”, and “platform.”

In addition, it should be understood that while the term “profit” is used herein as a measure of seller's success, and thus, as the basis of users' variable reward, other accounting values, such as the revenue (gross, net, etc) may be used to determine the users' variable reward, without departing from the scope of the invention. Thus, the percentage referred to above may be applied to any such accounting value that may measure seller's success in the market place, and to which users have contributed through their actions as described above. Thus, it should be noted that, what it is important is that users' reward is variable, thus, potentially great, depending on seller's success, and this approach gives extra incentives to users to perform the actions described above.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the described methods. Acts, elements and features discussed only in connection with one embodiment are not intended to be excluded from a similar role in other embodiments.

For means-plus-function limitations recited in the claims, the means are not intended to be limited to the means disclosed in this application for performing the recited function, but are intended to cover in scope any means, known now or later developed, for performing the recited function.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. An internet-based method for compensating non-commercial user actions, said method comprising the steps of: receiving from a seller a description of its product offering, and parameters of its offering including the percentage of seller's accounting value to be realized from the sale of the product during a preset sale period, which seller agrees to share with users who indicate interest in the seller's product; displaying at least a portion of the description of the seller's product offering on a document of a web platform; facilitating at least one indication of interest in the seller's product by users, including recording at least one of user's indication of interest; providing data to seller regarding the interest indicated by users in the seller's offering; receiving payment from seller, said payment including said percentage of seller's accounting value; and, distributing to users their share of the payment received from seller.

2. The method of claim 1, wherein the product is a song.

3. The method of claim 1, wherein one of the parameters of the seller's offering is the geographic location of the users.

4. The method of claim 1, further comprising displaying at least one of the parameters of seller's offering including the percentage of seller's accounting value, which seller agrees to share with users.

5. The method of claim 1, wherein the indication of interest in the seller's product is comprised of at least one of expressing interest and sharing interest.

6. The method of claim 5, wherein at least one of expressing interest and sharing interest is performed by the users through the web platform.

7. The method of claim 6, wherein the acts of expressing interest are performed by the users by clicking or touching a button displayed on a document of the web platform, and wherein the web platform records said acts and displays statistics about said acts, for all users to view.

8. The method of claim 5, wherein the acts of sharing interest are performed by the users through channels outside the web platform, and wherein said acts are reported by the users to the web platform.

9. The method of claim 1, wherein said data includes confirmation that a minimum number of interests were indicated by users.

10. The method of claim 1, wherein a portion of the payment received from seller is retained by the web platform's administrator.

11. An internet-based method for compensating non-commercial user actions, said method comprising the steps of: accessing a web platform; submitting to the web platform a description of a seller's product offering, and parameters of seller's offering including the percentage of seller's accounting value to be realized from the sale of the product during a preset sale period, which seller agrees to share with users who indicate interest in seller's product, wherein, at least a portion of the description of the seller's product offering is displayed on a document of the web platform; receiving data regarding the interest indicated by users in the seller's offering; providing seller's accounting value data to the web platform's administrator; and, submitting payment, said payment including said percentage of seller's accounting value, for distribution of their share to users who indicated interest in seller's product.

12. The method of claim 11, wherein the product is a song.

13. The method of claim 11, wherein one of the parameters of the seller's offering is the geographic location of the users.

14. The method of claim 11, further comprising displaying at least one of the parameters of seller's offering including the percentage of seller's accounting value, which seller agrees to share with users.

15. The method of claim 11, wherein the indication of interest in the seller's product is comprised of at least one of expressing interest and sharing interest.

16. The method of claim 15, wherein at least one of expressing interest and sharing interest is performed by the users through the web platform.

17. The method of claim 16, wherein the acts of expressing interest are performed by the users by clicking or touching a button displayed on a document of the web platform, and wherein the web platform records said acts and displays statistics about said acts, for all users to view.

18. The method of claim 15, wherein the acts of sharing interest are performed by the users through channels outside the web platform, and wherein said acts are reported by the users to the web platform for the purpose of receiving credit.

19. The method of claim 11, wherein said percentage of seller's accounting value is set by seller and approved by web platform's administrator.

20. A web platform comprising at least one member of a group consisting of server, program, data base, and document, said web platform being capable of: receiving from a seller a description of its product offering, and parameters of its offering including the percentage of seller's accounting value to be realized from the sale of the product during a preset sale period, which seller agrees to share with users who indicate interest in the seller's product; displaying at least a portion of the description of the seller's product offering on a document of a web platform; facilitating at least one indication of interest in the seller's product by users, including recording at least one of user's indication of interest; providing data to seller regarding the interest indicated by users in the seller's offering; receiving payment from seller, said payment including said percentage of seller's accounting value; and, distributing to users their share of the payment received from seller.
